(19) United States
(12) Patent Application Publication
(10) Pub. No.: US 2003/0125930 A1
(43) Pub. Date: Jul. 3, 2003

(54) Use of common words, and common word bound prefixes, infixes, and suffixes for natural language and genre determination; for serving as a student study aid of textbook material; for generating automated indexes, automated keywords of documents, and automated queries; for data-base reduction (compaction); and for sorting documents in heterogenous databases

(76) Inventor: Asa Martin Stepak, Lake Worth, FL (US)

Correspondence Address: Asa Martin Stepak, P.O. Box 540325, Lake Worth, FL, 33454, US

(21) Appl. No.: 10/166,329

(22) Filed: Aug. 4, 2001

(51) Int. Cl. G06F 17/27

(52) U.S. Cl. 704/9

(57) ABSTRACT

The use of ‘most common words’ of a language as token sets has great utility when used properly. The prior State of the Art, as exemplified by the invention described in Martino et al., U.S. Pat. No. 6,216,102, has not recognized the complete theoretical basis of ‘most common words’ that might explain why a small set of words represents a majority of the words used in language when language comprises of an infinite set of potential words. Thus, Martino et al. have introduced an invention that is limited in scope due to misconceptions based upon the prior State of the Art with respect to the true theoretical underpinnings of ‘most common words’. The prior ‘State of the Art’ excludes consideration of common affixes (bound MCW's) from the class of MCW's. In this application for which claims of invention are made, common affixes are considered as belonging to the class of MCW's.

### CROSS REFERENCE TO RELATED APPLICATIONS

Martino et al., U.S. Pat. No. 6,216,102, filed on Apr. 10, 2001

A process relying on the use of common words, and common word bound prefixes, infixes, and suffixes for Natural Language and Genre determination; for serving as a student study aid of textbook material; for generating automated indexes, automated keywords of documents, and automated queries; for data-base reduction (compaction); and for sorting documents in heterogeneous databases.

### STATEMENT REGARDING FEDERALLY SPONSORED RESEARCH OR DEVELOPMENT

Not Applicable

### DESCRIPTION OF ATTACHED APPENDIX

Not Applicable

### BRIEF SUMMARY OF THE INVENTION

Other objects and advantages of the present invention will become apparent from the following descriptions, wherein, by way of illustration and example, an embodiment of the present invention is disclosed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. I claim a method that serves as a substantial improvement to the method described in Martino et al., U.S. Pat. No. 6,216,102. The claim is based upon the theoretical perspective I have introduced that the set of MCW's comprise of both bound and unbound MCW's as determined by their frequency and iconicism. When considering the set of bound and unbound MCW's, using iconicism as a requsitie requirement for inclusion in the set, the number of MCW per unit coverage amongst the languages tend to equalize as does average character length of MCW's. Thus, when one expands the set of MCW's to include both bound and unbound MCW's, MCW's appear more appropriately designated a universal trait of all languages due to a more equal coverage achieved per MCW amongst the languages. However, the prior State of the Art does not view MCW's as having equal coverage amongst different languages or as a universal trait of languages.
The method used would proceed as described in Martino et al., U.S. Pat. No. 6,216,102. A four bit table representating hardware registers would be used as described in Martino et al. The departure from Martino et al. for which claim of invention is made is as follows:
In addition to unbound MCW's being counted by the bit tables, the registers would be configured to also count MCW bound prefixes and infixes. Thus, in the English language, the letter sequences th, un, and possibly ph would be added to the bit registers. Other MCW bound prefixes would already be accounted for by the non-bound MCW's counted by the bit tables. Also, to minimize weak aliases, a second bit table for each language would be created exclusively for MCW bound suffixes, i.e. ing, ed, es, s, etc. For words greater than four characters, the words would be truncated to 4 characters and then compared to the bit tables (as in Martino et al.). If there is no match, the same word would be, then, truncated to 3 letters by eliminating the rightmost character and again compared to the bit tables. If no match, the same word would be truncated one more time to 2 characters by eliminating the rightmost character and then compared with the bit table. Then, the word in its original form, non-truncated, would be truncated to three characters by eliminating the leftmost characters. The 3 character truncated word would then be compared with the suffix bit table. If no match, the 3 character truncated word would be truncated again to a two character word by eliminating the leftmost character and, then, compared with the suffix bit table. Finally, if no match, the 2 character truncated word would be truncated to one letter by eliminating the leftmost character and then compared with the suffix bit table. Then the next word in the text would be selected for comparison with the bit table. If the next word is a truncated word, the same cycle would repeat. When either of the two bit tables for each language achieve a predetermined threshold value or if the two tables in summation achieve a predetermined threshold value, identification of text is achieved. The methodology just described and for which claim of invention is made could be varied slightly based upon experience and any unexpected strong aliases occurring.
The method just described provides six separate potentially valid inputs for truncated words whereas in the Martino et al. method only one is provided. The new method described above and for which claim of invention is made in the instant application provides identification of genre and language substantially more rapidly and with substantially shorter text. It achieves this goals since it compares inflectional morphemes, occurring commonly in language and characteristically different in different languages. The frequency of these morphemes and there iconic feature qualify them for being included in the set of MCW's.

2. Studying and learning textbook material involves constructing mental images and/or mental lexicons that enable the user to regurgitate, recite, and/or implement the knowledge representation in a manner that denotes understanding. The process involves the ability to associate and/or configure distinct conceptual and/or tangible objects as represented to the user by word objects of the text. The words come in two forms, MCW/iconic and uncommon/non-iconic. MCW iconic words comprise primarily of the irregular verbs, pronouns and reflexive pronouns, intransitive and modal verbs that in totality represent the body of syncategorematic words that construct the relationships between the uncommon word objects that, in turn, represents the relationship or configuration of the conceptual and/or tangible objects to be learned. Understanding and learning is achieved once the user can ascertain the proper configuration and/or relationship between objects without the “crutch” of having to rely on the syncategorematic body segment of words that originally instructed the user. In the prior State of the Art, exercises used to measure or promote learning fail to recognize the importance of the above principle and, as such, fail to obviate syncategorematic cues. To the extent syncategorematic cues are not obviated, learning becomes less efficient and measurements of learning become less accurate. Claimed herein as an invention is a new method for promoting and measuring learning that excludes syncategorematic cues relying on a automated extraction of syncategorematic word objects or MCW's. A description of the method is as follows:
After the user studies a chapter from a textbook, the user scans the chapter on a scanner that creates a text file in memory linked to a processor. Then, in a automated fashion, without user interaction, all syncategorematic words, MCW's, are extracted from the text file, (the 300 most commonly used words representing roughly 65% of the words used are extracted with the exception of the negative words, “no” and “don't”). Punctuation is also extracted except end of sentence punctuation. A forward slash might be substituted for a end of sentence period and a backward slash substituted for a question mark. The user is then provided the post extracted text and, also, provided the list of MCW's used as the template of extraction. At this point the user has the option to answer the homework problems at the end of the chapter using both the textbook and post extracted text as a reference or may proceed to do the following. A second post extracted text is made available to the user that has white space areas representing where the original text was extracted. Using the extraction template as a reference, the user is then asked to fill the white space with syncategorematic words (MCW's) in a manner that represents the proper relationship of the non-syncategorematic non extracted words that are spaced apart. If the user is able to complete this exercise in a manner that corresponds fairly well with the original non-extracted text, the user can be considered as having learned the material. The user is then encouraged to use the post extracted text, (the one devoid of white space gaps) as a study guide in preparation of quizzes or exams or for completing related exercises or projects.
It should be pointed out, the method described above for which claim of invention is made, is completely automated, involving no human interaction that could bias the learning or testing process. The theoretical concept upon which it is based is not part of the prior State of the Art. The method relies on a small set of MCW's, syncategorematic words, serving as the nuts, bolts, and cement that establish the configuration of objects to be learned (understanding), the objects represented by the non-syncategorematic word object segment of the text.
The methodology as described above could be modified as called for based upon the preferences of the user and experience with the system. For instance, different exercises could be implemented that were based upon the same learning principle. The user might be given an exercise of writing a list in order of frequency or importance of as many of the important uncommon words in the text that might be represented as keywords. The user would only have a MCW extraction template to refer to during the exercise which would indicate words automatically eliminated from the list. After completing the exercise, the user would be provided a list of the uncommon words in the text sorted on the basis of frequency with which he would compare his responses. The objective of the user would not be to completely match the list, but rather, recall several keywords of the text, perhaps as many of 5 to 10, that would be confirmed by their presence on the uncommon word list. In doing this exercise, the user might want to raise the level of extraction from 300 MCW's to a substantially higher level depending on the nature of the text.
